(19) United States
(12) Patent Application Publication
(10) Pub. No.: US 2014/0158306 A1
(43) Pub. Date: Jun. 12, 2014

(54) DEVICE FOR DETACHING A COVER FROM A BASE

(71) Applicants: HON HAI PRECISION INDUSTRY CO., LTD., New Taipei (TW); Fu Tai Hua Industry (Shenzhen) Co., Ltd., Shenzhen (CN)

(72) Inventor: Zhan-Sheng LU, Shenzhen (CN)

(73) Assignees: HON HAI PRECISION INDUSTRY CO., LTD., New Taipei (TW); Fu Tai Hua Industry (Shenzhen) Co., Ltd., Shenzhen (CN)

(21) Appl. No.: 13/973,980

(22) Filed: Aug. 22, 2013

(30) Foreign Application Priority Data
Dec. 7, 2012 (CN) 2012105215250

(51) Int. Cl. B32B 43/00

(52) U.S. Cl. CPC B32B 43/006
USPC 156/752

(57) ABSTRACT

A device for detaching a cover adhesively attached to a base is provided. The device includes a support plate for supporting the base, and a suction plate applying an overall and uniform attracting action to the cover by means of a vacuum. The device further includes a driving unit to pull the suction plate away from the base. The device further includes a heating element to heat and soften adhesive, thereby weakening the adhesive bond between the base and the cover and allowing the release of the cover from the base.

### BACKGROUND

1. Technical Field

The present disclosure relates to a device for detaching a cover from a base.

2. Description of Related Art

During manufacturing, electronic devices may include a cover and a base that are connected together by an adhesive tape, and the cover needs to be detached from the base when reworking some of the electronic devices. Thus, there is a need to provide a device to quickly and completely detach the cover from the base.

### BRIEF DESCRIPTION OF THE DRAWINGS

Many aspects of the embodiments can be better understood with reference to the following drawings. The components in the drawings are not necessarily drawn to scale, the emphasis instead being placed upon clearly illustrating the principles of the present disclosure. Moreover, in the drawings, like reference numerals designate corresponding parts throughout the several views.

FIG. 1 is an isometric view of a detaching device according to one embodiment.

FIG. 2 an isometric, exploded view of the detaching device of FIG. 1.

FIG. 3 is a cross-sectional view of the detaching device of FIG. 1, taken along lines III-III of FIG. 1.

FIG. 4 is an enlarged view of the portion IV of FIG. 3.

### DETAILED DESCRIPTION

Embodiments of the present disclosure will be described with reference to the accompanying drawings.

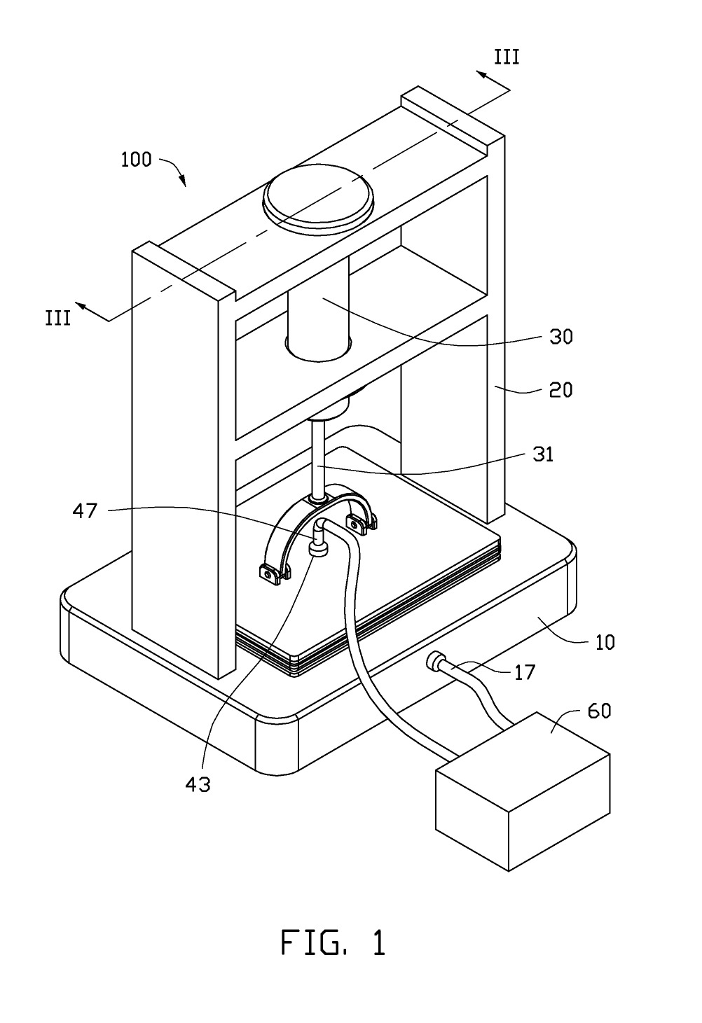

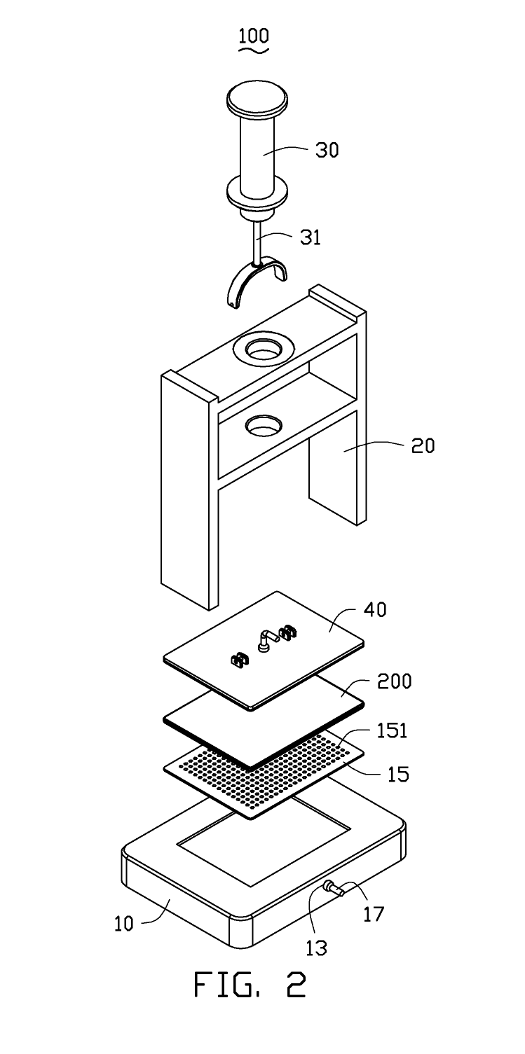

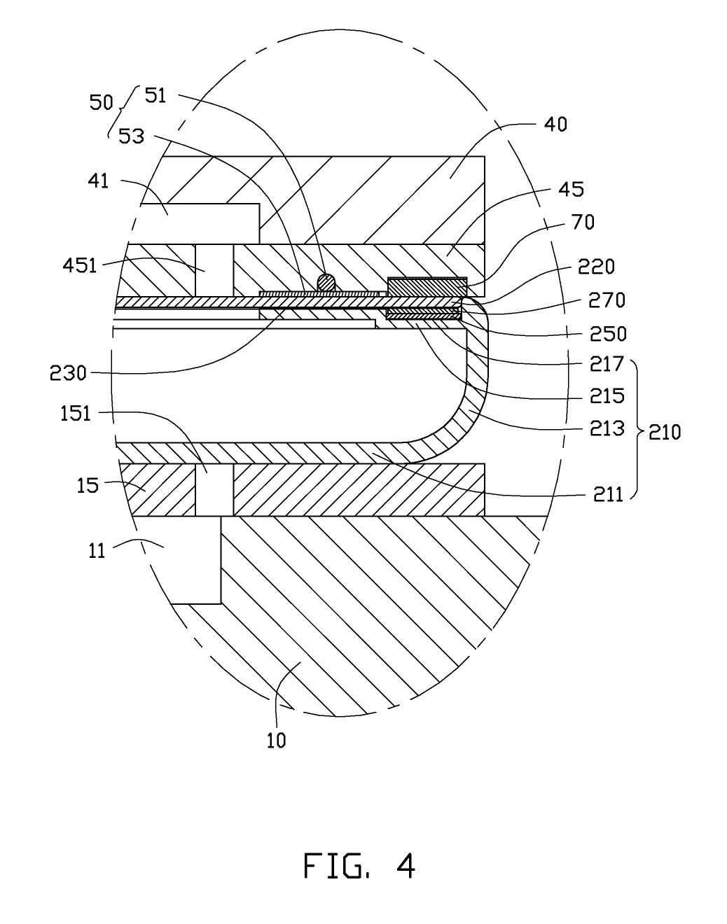

Referring to FIGS. 1-2, a detaching device 100 is used to detach a cover 220 (FIG. 4) of an electronic device 200 from a base 210. The base 210 includes a lower plate 211, a sidewall 213, and a support flange 215 protruding inwardly from the top of the sidewall 213. The cover 220 is secured to the support flang 215 by adhesive tape 230. The support flang 215 defines a recess 217 that accommodates a magnet 250. A ferromagnetic metal 270 is arranged on the inner surface of the cover 220, and rests on the magnet 250.

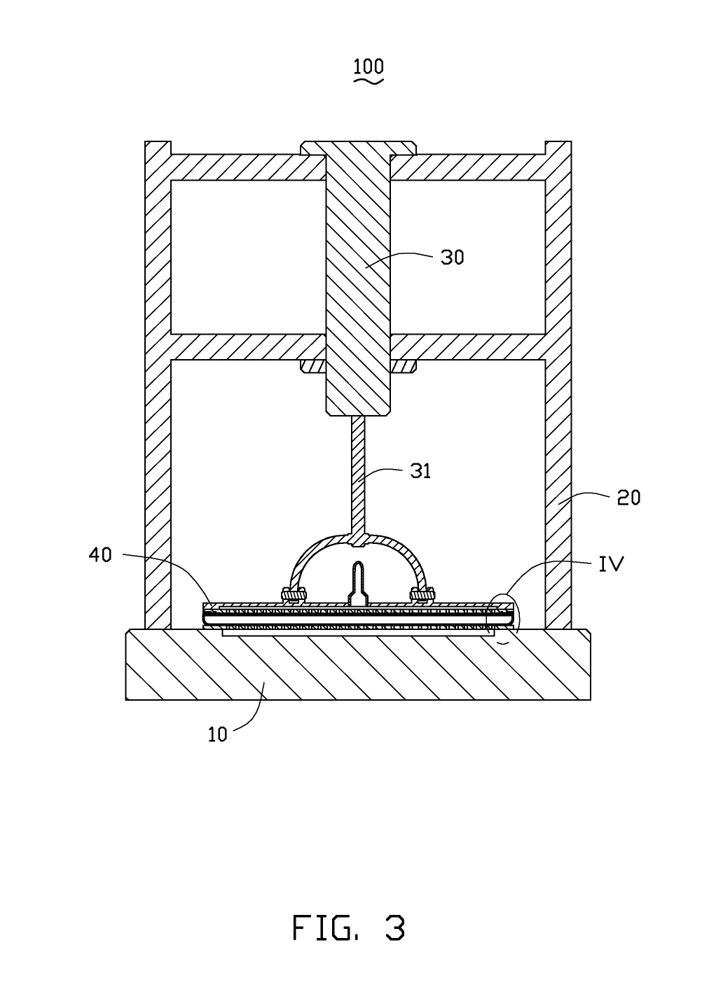

Referring to FIGS. 3-4, the detaching device 100 further includes a platform 10, a support frame 20, a driving unit 30, and a suction member 40. The platform 10 defines a chamber 11 in its top surface and has a connector 13 communicating with the chamber 11. The chamber 11 is covered by a support plate 15 that supports the base 210 of the electronic device 20. The support plate 15 defines a number of through holes 151 that communicate with the chamber 11. The connector 13 is connected to a vacuum source 60 via a pipe 17. The air can be drawn out of the chamber 11 through the connector 13, thereby creating a vacuum in the chamber 11. The base 210, which is located on the support plate 15 and covers all the through holes 151, can thus be strongly attracted to the support plate 15 and held by it.

The support frame 20 is secured to the top surface of the platform 10. The driving unit 30 is secured to the support frame 20, and includes a rod 31 that can move toward and away from the platform 10. In the embodiment, the driving unit 30 is a pneumatic cylinder.

The suction member 40 is connected to the lower end of the rod 31, and defines a cavity 41 and has a connector 43 communicating with the cavity 41. The cavity 41 is covered by a suction plate 45. The suction plate 45 defines a number of through holes 451 that communicate with the cavity 41. The connector 43 is connected to a vacuum source 60 via a pipe 47. The suction plate 45 can move toward the platform 10 to a position where the suction plate 45 is in contact with the top surface of the cover 220 of the electronic device 200, the through holes 451 then being covered. The air can be drawn out of the cavity 41 through the connector 43, thereby creating a vacuum in the cavity 41. The cover 220 can thus be drawn by negative air pressure to the suction plate 45.

The detaching device 100 further includes a heating element 50. The heating element 50 heats and softens the adhesive tape 230, thereby weakening the bond between the base 210 and the cover 220, and allowing the cover 220 to be released from the base 210. The cover 220 is thus detached from the base 210.

In the embodiment, the heating element 50 includes a heating wire 51 and a thermally conductive pad 53. The heating wire 51 is embedded in the suction plate 45, and the thermally conductive pad 53 is secured to the suction plate 45 and covers the heating wire 51. The thermally conductive pad 53 transfers the heat generated by the heating wire 51 to the cover 220.

In the embodiment, the detaching device 100 further includes a magnet 70. The magnet 70 is secured to the suction plate 45, and is arranged in such a way that the magnet 70 is located above the ferromagnetic metal 270 when the suction plate 45 is in contact with the cover 220. The magnet 70 attracts the ferromagnetic metal 270, which allows the ferromagnetic metal 270 to move upward together with the cover 200.

While various embodiments have been described and illustrated, the disclosure is not to be construed as being limited thereto. Various modifications can be made to the embodiments by those skilled in the art without departing from the true spirit and scope of the present disclosure as defined by the appended claims.

What is claimed is:

1. A detaching device for detaching a cover of an electronic device from a base of the electronic device, the detaching device comprising:
a platform defining a chamber and comprising a first connector for connecting with a vacuum source, the platform further comprising a support plate defining a plurality of through holes that communicate with the chamber, the support plate being configured to support the base of the electronic device, wherein the base of the electronic device is sucked to the support plate when a vacuum condition is created in the chamber by the vacuum source;
a support frame secured to the platform;
a driving unit secured to the support frame and comprising a rod that is movable toward or away from the platform;
a suction member connected to an end of the rod, the suction member defining a cavity and comprising a second connector for connecting with the vacuum source, the suction member further comprising a suction plate that defines a plurality of openings communicating with the cavity, the suction member being configured to suck the cover of the electronic device when a vacuum is created in the cavity by the vacuum source; and
a heating element secured to the suction plate and configured to heat and soften a glue tape between the between the cover and the base, thereby allowing the cover to move together with the suction member.

2. The electronic card connector according to claim 1, wherein the driving unit is a pneumatic cylinder.

3. The electronic card connector according to claim 1, wherein the heater comprises a heating wire and a thermally conductive pad, the thermally conductive pad is configured to transfer heat from the heating wire to the cover of the electronic device.

4. The electronic card connector according to claim 1, further comprising a magnet secured to the suction plate, wherein the magnet is configured to attract a metal piece within the electronic device.
